(19) United States
(12) Patent Application Publication
(10) Pub. No.: US 2026/0275781 A1
(43) Pub. Date: Sep. 17, 2026

(54) Door Security Assembly With Unlocking Device

(71) Applicants: Joseph Curtis TAYLOR, Birch Run, MI (US); Jack Roy Taylor, Cilo, MI (US)

(72) Inventors: Joseph Curtis TAYLOR, Birch Run, MI (US); Jack Roy Taylor, Cilo, MI (US)

(21) Appl. No.: 19/564,957

(22) Filed: Mar. 12, 2026

Related U.S. Application Data
(60) Provisional application No. 63/771,466, filed on Mar. 13, 2025.

(51) Int. Cl. E05C 19/00

(52) U.S. Cl. CPC E05C 19/003

(57) ABSTRACT

A door security assembly may lock or barricade a door in a closed position. The door security assembly may include a barricade assembly and a disengagement assembly. The barricade assembly can have a barricade, a door plate, and a floor plate. The disengagement assembly can have an extension and an adapter. The extension can extend vertically from the barricade, and the adapter can attach to a door handle of a door. By rotating the door handle of a door, the adapter can transmit motion to the extension and disengage the barricade and allow opening of the door.

### CROSS-REFERENCE TO RELATED APPLICATIONS

This application claims the benefit of U.S. Provisional Application No. 63/771,466, filed on Mar. 13, 2025. The entire disclosure of the above application is incorporated herein by reference.

### FIELD

The present disclosure relates to a door security assembly having an unlocking or disengagement device.

### BACKGROUND

This section provides background information related to the present disclosure and is not necessarily prior art.

A door security assembly may include a barricade (or door-locking handle) that may engage a door to barricade the door in a closed position to restrict entry into a building and/or into a room within a building during emergency situations, such as a school lockdown for example. The present disclosure provides a door security assembly with a disengagement (unlocking) assembly for unbarricading a door. The disengagement assembly facilitates fast and easy disengagement of the barricade from the door during urgent, high-stress emergency situations or non-emergency situations for example.

### SUMMARY

This section provides a general summary of the disclosure and is not a comprehensive disclosure of its full scope or all of its features.

The present disclosure provides a door security assembly for barricading a door. The door security assembly includes a plate, a door-locking handle, and a disengagement assembly. The door-locking handle is configured to engage the plate and cooperate with the door plate to barricade the door in a closed position. The disengagement assembly includes an extension and an adapter. The extension is connected to and extends vertically from the door-locking handle. The adapter is connected to the extension and a door handle of the door. The disengagement assembly is configured to transmit motion of the door handle to the door-locking handle to disengage the door-locking handle from the door plate.

In some configurations of the door security assembly of the above paragraph, the extension is a strap including a first end and a second end, the first end of the strap is connected to the door-locking handle.

In some configurations of the door security assembly of either or both of the above paragraphs, the strap includes a strap adjuster configured to length and shorten the strap.

In some configurations of the door security assembly of any one or more of the above paragraphs, the strap includes a strap buckle configured to attach and remove the strap from the door-locking handle.

In some configurations of the door security assembly of any one or more of the above paragraphs, the adapter is formed from a resiliently bendable material.

In some configurations of the door security assembly of any one or more of the above paragraphs, the adapter is a cylindrical shape with an outer circumference and an inner circumference.

In some configurations of the door security assembly of any one or more of the above paragraphs, the adapter includes a door handle slot, and the inner circumference of the adapter is configured to surround a door handle of the door via the door handle slot.

In some configurations of the door security assembly of any one or more of the above paragraphs, the door handle slot of the adapter includes an engagement feature configured to interfere with at least one of a lever of the door handle and a spherical shape of the door handle to restrict disengagement of the adapter from the door handle.

In some configurations of the door security assembly of any one or more of the above paragraphs, the adapter includes a protrusion extending from the outer circumference of the adapter configured to attach the extension and provide leverage to disengage the door-locking handle from the door plate.

In some configurations of the door security assembly of any one or more of the above paragraphs, the plate is a door plate including a slot removably engaging the door-locking handle and configured to be mounted to the door.

In some configurations of the door security assembly of any one or more of the above paragraphs, the door-locking handle includes a first leg and a second leg, the first leg of the door-locking handle is configured to engage at least one of a door soffit and a floor plate, the second leg of the door-locking handle is configured to slidably mount to the door plate.

In some configurations of the door security assembly of any one or more of the above paragraphs, the floor plate is configured to mount to a floor, the floor plate includes an aperture, the aperture is configured to receive the first leg of the door-locking handle.

In some configurations of the door security assembly of any one or more of the above paragraphs, the plate is a floor plate including an aperture configured to be mounted to a floor. The floor plate includes an aperture that removable receives the door-locking handle.

The present disclosure also provides a door security assembly for barricading a door. The door security assembly includes a door-locking handle, a plate, and a disengagement assembly with an extension and an adapter. The door plate is configured to removably engage the door-locking handle. The extension of the disengagement assembly includes a first end, a second end, and an intermediate portion extending between the first end and the second end. The first end of the extension is connected to and extends vertically from the door-locking handle. The adapter of the disengagement assembly is connected to the second end of the extension and includes a door handle slot and an engagement feature. The door handle slot is configured to at least partially surround a door handle of the door. The engagement feature is configured to engage the door handle of the door. The adapter is configured to transmit rotational movement of the door handle to vertical movement of the extension, which moves the door-locking handle relative to the door plate.

In some configurations of the door security assembly of the above paragraph, the extension is a strap and includes a strap adjuster and a buckle. The strap adjuster is configured to adjust a length of the strap, and the buckle is configured to removably attach the strap to the door-locking handle.

In some configurations of the door security assembly of either or both of the above paragraphs, the adapter is a resiliently bendable material having a cylindrical shape with an outer circumference and an inner circumference.

In some configurations of the door security assembly of any of the above paragraphs, the inner circumference of the adapter is configured to surround the door handle of the door via the door handle slot.

In some configurations of the door security assembly of any of the above paragraphs, the engagement feature of the adapter is configured to interfere with at least one of a lever of the door handle and a spherical shape of the door handle to restrict disengagement of the adapter from the door handle.

In some configurations of the door security assembly of any of the above paragraphs, the adapter includes a protrusion extending from the outer circumference of the adapter configured to attach the extension and provide leverage to disengage the door-locking handle from the plate.

In some configurations of the door security assembly of any one or more of the above paragraphs, the plate is a door plate including a slot removably engaging the door-locking handle and configured to be mounted to the door.

In some configurations of the door security assembly of any of the above paragraphs, the door-locking handle includes a first leg and a second leg, the first leg of the door-locking handle is configured to engage at least one of a door soffit and a floor plate, the second leg of the door-locking handle is configured to slidably mount to the door plate.

In some configurations of the door security assembly of any one or more of the above paragraphs, the plate is a floor plate including an aperture configured to be mounted to a floor. The floor plate includes an aperture that removable receives the door-locking handle.

The present disclosure also provides a door security assembly that includes a door-locking handle, a door plate, and a rigid rod. The door plate is configured to removably engage the door-locking handle. The rigid rod includes a first end, a second end, and an intermediate portion extending between the first end and the second end. The first end of the rigid rod is connected to and extends vertically from the door-locking handle. Movement of the rigid rod causes corresponding movement of the door-locking handle relative to the plate.

In some configurations of the door security assembly of the above paragraph, the door-locking handle includes a first leg and a second leg. The first leg of the door-locking handle is configured to engage at least one of a door soffit and a floor plate. The second leg of the door-locking handle is configured to slidably mount to the plate.

In some configurations of the door security assembly of the above paragraphs, the plate is a door plate configured to be mounted to the door. The door plate includes a slot that removably engages the door-locking handle.

In some configurations of the door security assembly of the above paragraphs, the plate is a floor plate configured to be mounted to a floor. The floor plate includes an aperture that removable receives the door-locking handle.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a perspective view of a door security assembly in an engaged position to lock or barricade a door in a closed position according to the principles of the present disclosure;

FIG. 2 is a perspective view of the door security assembly in a disengaged (or unlocked, unbarricaded) position;

FIG. 3 is an exploded perspective view of the door security assembly;

FIG. 4 is a perspective view of a door-locking handle and a door plate of the door security assembly;

FIG. 5 is a perspective view of the door plate of the door security assembly;

FIG. 6 is another perspective view of the door plate of the door security assembly;

FIG. 7 is another perspective view of the door-locking handle and the door plate with an unbuckled buckle of the door security assembly;

FIG. 8 is another perspective view of the door-locking handle and the door plate with hook-and-loop fasteners;

FIG. 9 is a front view of an adapter of the door security assembly;

FIG. 10 is a front view of the adapter of the door security assembly and a door handle;

FIG. 11 is a side view of the adapter of the door security assembly and the door handle;

FIG. 12 is a front view of the adapter of the door security assembly engaged to the door handle;

FIG. 13 is a side view of the adapter of the door security assembly engaged to the door handle;

FIG. 14 is a perspective view of the adapter of the door security assembly;

FIG. 15 is another perspective view of the adapter of the door security assembly;

FIG. 16 is a front view of the adapter of the door security assembly engaged to a door handle;

FIG. 17 is a front view of another example of an adapter of a door security assembly and the door handle;

FIG. 18 is a perspective view of the adapter of the door security assembly engaged to the door handle;

FIG. 19 is a side view of the adapter of the door security assembly engaged to the door handle;

FIG. 20 is a side view of the adapter of the door security assembly and the door handle;

FIG. 21 is a perspective view of the adapter of the door security assembly and the door handle;

FIG. 22 is a perspective view of another example of a door security assembly with a rigid extension in an engaged position;

FIG. 23 is a perspective view of the door security assembly with the rigid extension in a disengaged position;

FIG. 24 is a perspective view of the door-locking handle of the door security assembly with the rigid extension and the door plate;

FIG. 25 is a perspective view of another example of a door security assembly in an engaged position;

FIG. 26 is a perspective view of the other example of the door security assembly in a disengaged position;

FIG. 27 is a perspective view of the other example door security assembly in the engaged position with a rigid extension; and

FIG. 28 is a perspective view of the other example door security assembly in the disengaged position with the rigid extension.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers, and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

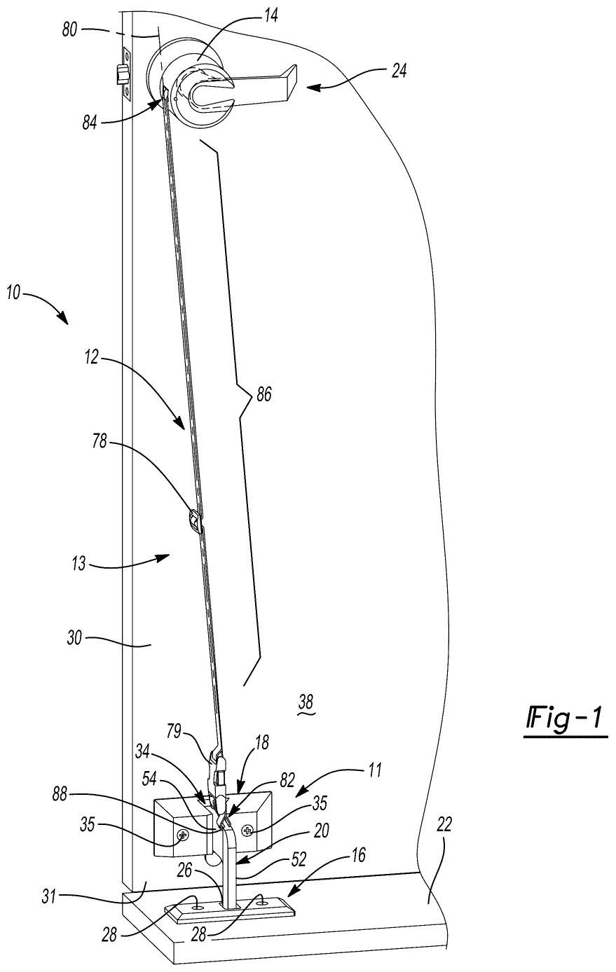

With reference to FIG. 1, a first example door security assembly 10 is provided. The door security assembly 10 in this example may include a barricade assembly 11 and a disengagement assembly 13. The barricade assembly 11 can include a first plate (e.g., a floor plate) 16, a second plate (e.g., a door plate) 18, and a door-locking handle (e.g., a barricade) 20. The disengagement assembly 13 can include an extension 12 and an adapter (e.g., door-handle engagement) 14. The door security assembly 10 can be deployed to barricade a door 30 in a closed position to prevent unwanted opening of the door 30. The door-locking handle 20 can be engaged with the floor plate 16 and the door plate 18 to prevent a person on the opposite side of the door 30 from opening the door 30, thereby preventing the person from gaining access to a room or space in a building or home, for example.

The door security assembly 10 in the first example shown in FIG. 1 may inhibit the door 30 from opening in both an inward direction (toward the room containing the door security assembly 10) and outward direction (away from the room containing the door security assembly 10). The extension 12 and the adapter 14 of the disengagement assembly 13 can be useful for people with injuries or other types of physical constraints to disengage (e.g., unbarricade, unlock) the door-locking handle 20 from either or both of the floor plate 16 and the door plate 18. When the door-locking handle 20 is disengaged from either or both of the floor plate 16 and the door plate 18, the door 30 can be moved between open and closed positions.

As shown in FIGS. 1-3, the floor plate 16 may be mounted to a floor 22 of a room of a building, for example. The floor plate 16 may include a first aperture 26 extending at least partially therethrough and one or more second apertures 28 extending therethrough. The first aperture 26 may be disposed between the second apertures 28. Fasteners 35 may extend through the second apertures 28 to fixedly mount the floor plate 16 to receiving holes 36 on the floor 22.

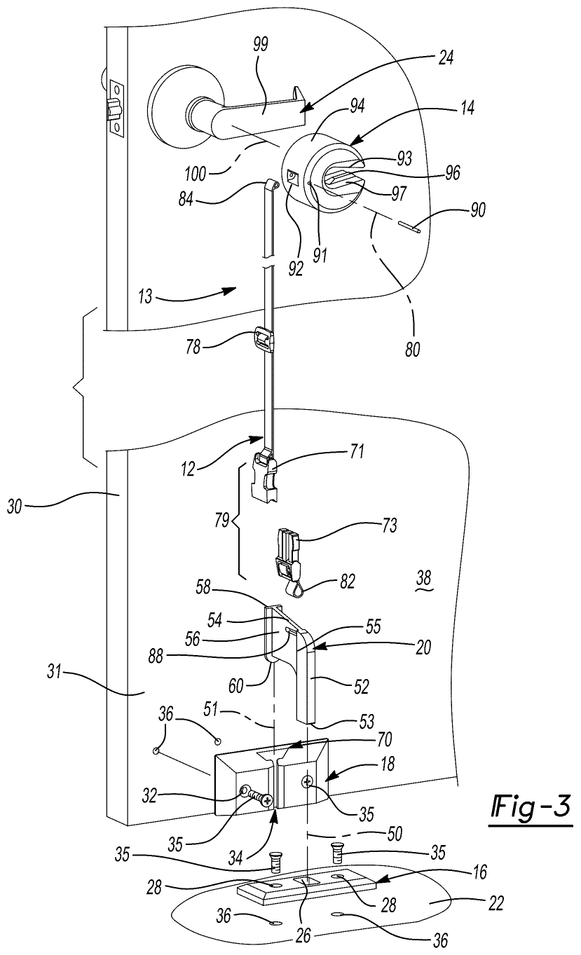

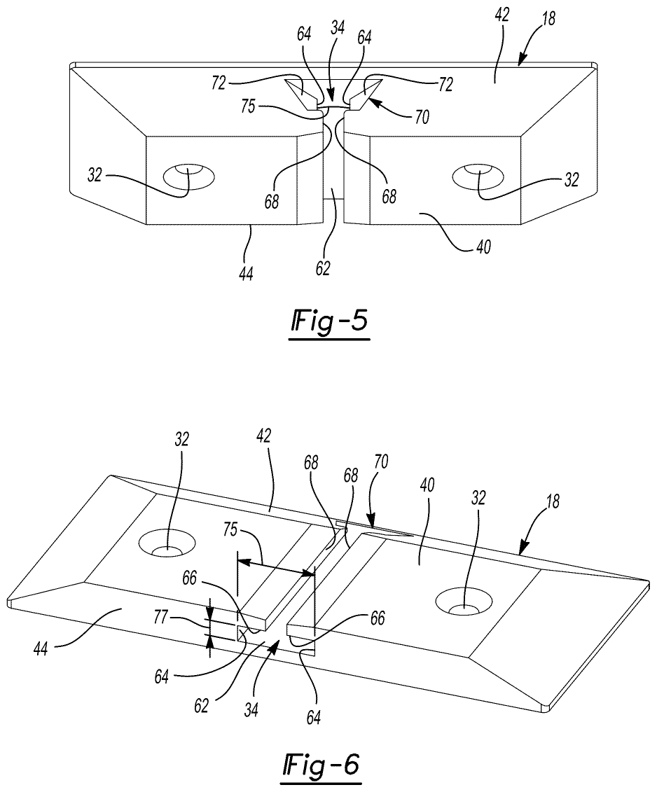

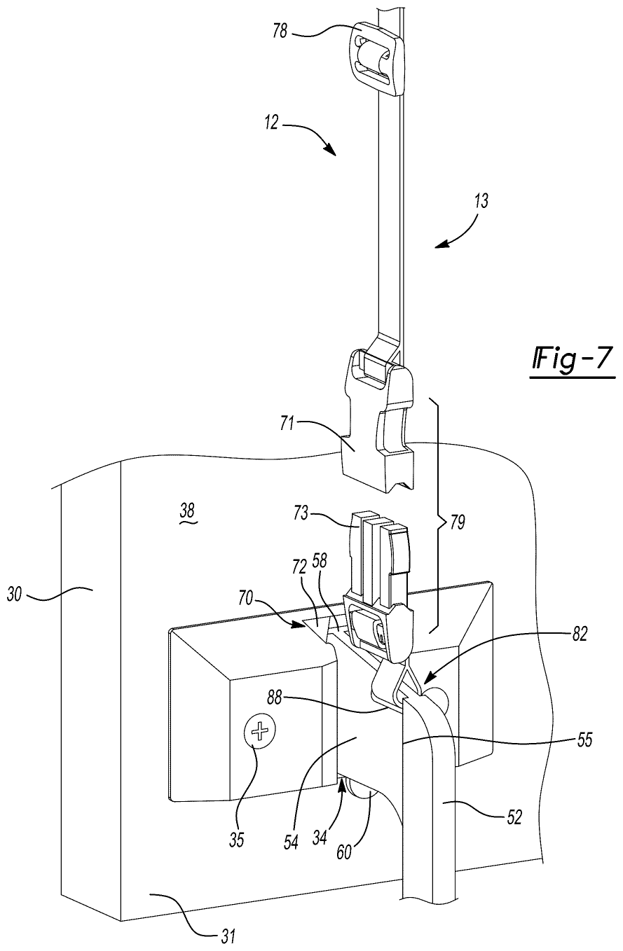

The door plate 18 may be mounted to a surface 38 of the door 30 of the building. As shown in FIG. 1, the door plate 18 may be mounted near or at a lower corner 31 of the door 30. The door plate 18 may include apertures 32 (FIGS. 3-5) extending therethrough and a slot 34. Fasteners 35 may extend through the apertures 32 of the door plate 18 to fixedly mount the door plate 18 to the receiving holes 36 on a surface 38 of the door 30. For example, the surface 38 of the door 30 may be an inner surface of the door 30 that is accessible by people inside of the room of the building and inaccessible by people outside the room when the door 30 is in a closed position.

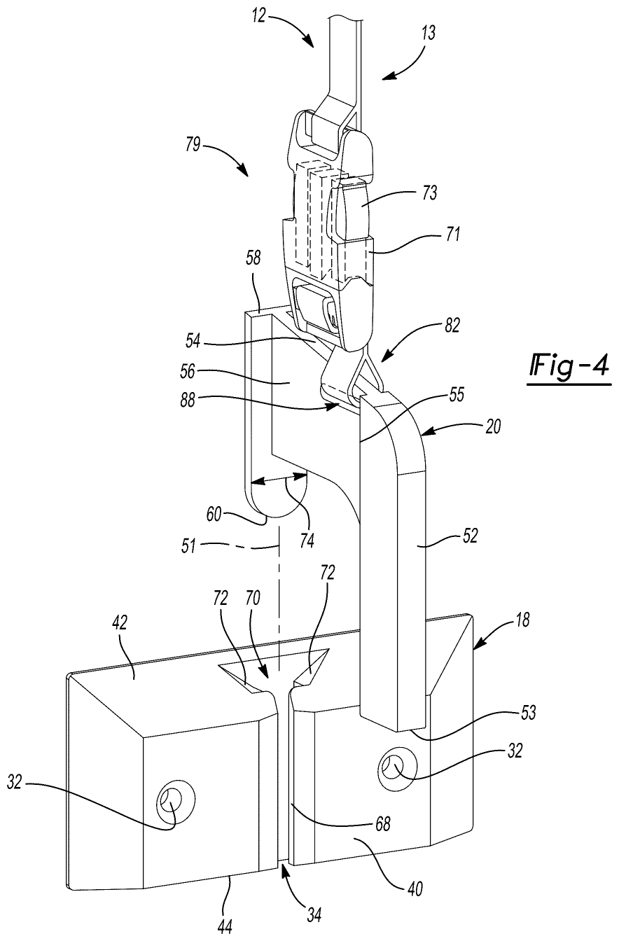

As shown in FIG. 4, the door plate 18 may include a front face 40, a back face (e.g., the surface that faces and contacts the surface 38 of the door 30) (not numbered), an upper surface 42, and a lower surface 44. The slot 34 may be formed in the door plate 18 between the apertures 32, and may extend into the front face 40 and through the upper and lower surfaces 42, 44. That is, the slot 34 may extend longitudinally in a vertical direction and through the upper and lower surfaces 42, 44. In some configurations, the upper surface 42 may be disposed at a non-perpendicular angle relative to the front face 40 and the back face. In some configurations, the lower surface 44 may be disposed at a perpendicular angle relative to the front face 40 and the back face.

As shown in FIGS. 1-4, the door-locking handle 20 may be a generally L-shaped member made of a metallic material, for example. The door-locking handle 20 may include a first leg 52 and a second leg 54. The first leg 52 may extend generally in a vertical direction along a leg axis 50 that allows the door-locking handle 20 to engage with the first aperture 26 of the floor plate 16. The first leg 52 may have a shape (profile) that corresponds to the shape of the first aperture 26 of the floor plate 16 such that at least a first end 53 of the first leg 52 can be received in the first aperture 26.

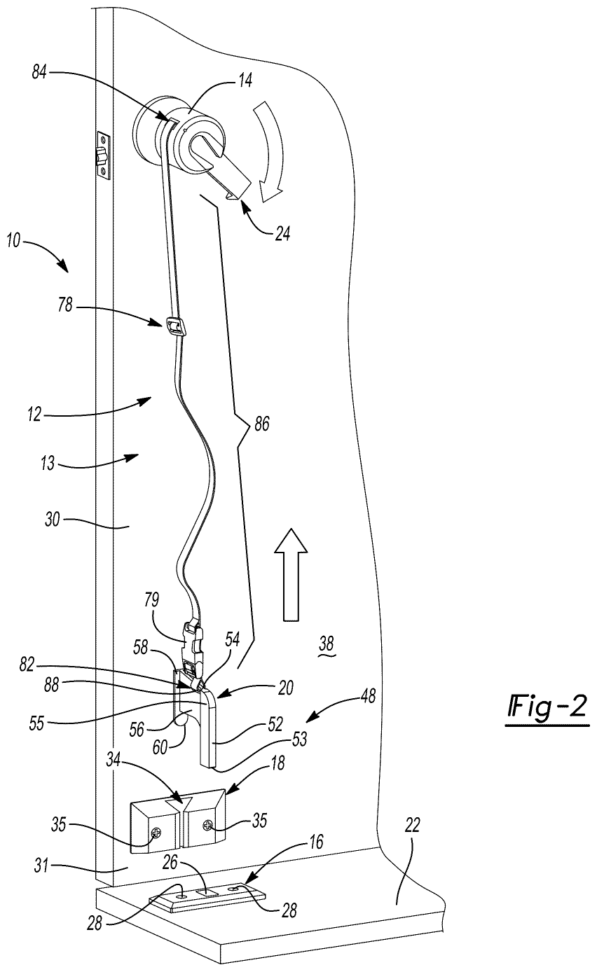

As shown in FIGS. 2-4, the second leg 54 may extend outward from a second end 55 the first leg 52 in a generally horizontal direction. In some configurations, the first leg 52 may have a thickness that is greater than a thickness of the second leg 54. The second leg 54 may include a body portion 56 and a flange portion 58. The body portion 56 may extend between the flange portion 58 and the first leg 52. The flange portion 58 is attached to one end of the body portion 56 and the first leg 52 is attached to the opposite end of the body portion 56. The body portion 56 and flange portion 58 may cooperate to form a generally T-shaped profile (or cross-sectional shape). That is, the flange portion 58 extends laterally outward in opposing directions from the end of the body portion 56. The flange portion 58 may include a tapered or curved lower end 60. The body portion 56 can include a strap slot 88 through which the extension 12 may attach and extend from.

As shown in FIGS. 1 and 2, the door-locking handle 20 may be movable between an engaged or locked position (FIG. 1) and a disengaged or unlocked position (FIG. 2). The door security assembly 10 is in the engaged position when the first end 53 of the first leg 52 of the door-locking handle 20 is seated (e.g. received, engaged, etc.) within the first aperture 26 of the floor plate 16 and the flange portion 58 of the second leg 54 is slotted (e.g. received, seated, etc.) within the slot 34 of the door plate 18. In the engaged position, the door-locking handle 20 may prevent the door 30 from being moved from the closed position to an open position. The door security assembly 10 is in the disengaged position when the first end 53 of the first leg 52 is not seated within the first aperture 26 of the floor plate 16 and/or when the flange 58 of door-locking handle 26 is not received within the slot 54 of the door plate 18.

As shown in FIG. 1, when the door-locking handle 20 is in the engaged position, the first leg 52 may be received in the first aperture 26 in the floor plate 16 and the second leg 54 may be received in the slot 34 of the door plate 18. That is, when the door-locking handle 20 is engaged with the door plate 18 and floor plate 16, the flange portion 58 of the second leg 54 is received in the slot 34, and the body portion 56 of the second leg 54 is partially received in the slot 34 and extends perpendicularly out of the slot 34.

Removing the first leg 52 of the door-locking handle 20 from the first aperture 26 of the floor plate 16 places the door security assembly 10 in the disengaged position from the engaged position. The disengaged position allows the door 30 to move from the closed position to the open position. When the door-locking handle 20 is in the engaged position, people, for example, in other areas of the building (e.g., a hallway or other rooms of the building) may be prevented from gaining access to the room or space in which the door security assembly 10 is installed. For example, the door-locking handle 20, through engagement of the first leg 52 with the first aperture 26 of the floor plate 16, operates to oppose forces applied to the door 30 from outside the room or space in which the door security assembly 10 is installed, thereby preventing the door 30 from being moved from the closed position to the open position.

As shown in FIGS. 3-6, the slot 34 of the door plate 18 can have a generally T-shaped profile that is sized and shaped to correspond to (and receive) the generally T-shaped profile formed by the body portion 56 and flange portion 58 of the door-locking handle 20 along a flange axis 51. The T-shaped profile extends along the longitudinal length of the slot 34 from the lower surface 44 up to the upper surface 42.

As shown in FIGS. 4-6, the T-shaped profile is defined by a back surface 62, a pair of opposing outer lateral surfaces 64, a pair of front surfaces 66, and a pair of opposing inner lateral surfaces 68. The outer lateral surfaces 64 extend from opposite sides of the back surface 62 and may be parallel to each other. The front surfaces 66 are spaced apart from the back surface 62 and extend from respective ones of the outer lateral surfaces 64. That is, the front surfaces 66 extend inwardly toward each other from the respective outer lateral surfaces 64. The front surfaces 66 may be coplanar with each other. The inner lateral surfaces 68 are spaced apart from each other and may be generally parallel to each other. The inner lateral surfaces 68 extend from respective ones of the front surfaces 66 in a direction away from the back surface 62. The inner lateral surfaces 68 may also be parallel to the outer lateral surfaces 64.

A flange width 74 of the flange portion 58 may be slightly smaller than an outer lateral surface width 75 between the outer lateral surfaces 64 of the slot 34. Similarly, a flange depth 77, the length the flange portion 58 extends from the second leg 54, may be slightly smaller than a slot depth 77 that is the distance between the front surfaces 66 and the back surface 62. The flange width 74 being smaller than the outer lateral surface width 75 and the flange depth 77 being smaller than the slot depth 77 allows the slot 34 to wholly receive the flange portion 58 of the second leg 54.

The slot 34 may also include a flared portion (an engagement feature) 70 in a portion of the slot 34 useful for providing rapid acceptance (e.g., engagement, receipt, etc.) of the body 56 and the flange portion 58 of the door-locking handle 20. The flared portion 70 flares outwardly from the T-shaped profile. The flared portion 70 may include a pair of ramped surfaces 72. Each of the ramped surfaces 72 extends laterally outward from a respective one of the outer lateral surfaces 64. That is, the ramped surfaces 72 extend from the outer lateral surfaces 64 away from the inner lateral surfaces 68 and upward away from the lower surface 44 of the door plate 18.

The ramped surfaces 72 are at non-perpendicular angles relative to each other, relative to the outer lateral surfaces 64, and relative to the upper surface 42 of the door plate 18. In some configurations, the ramped surfaces 72 extend a greater distance laterally outward (i.e., away from the outer lateral surfaces 64) than the lateral distance between adjacent outer and inner surfaces 64, 68. The ramped surfaces 72 may taper to a point (or taper smaller and smaller) as they extend upward (away from the lower surface 44) and laterally outward. In some configurations, the ramped surfaces 72 may be perpendicular to each other.

As shown in FIGS. 4-6, the flared portion 70 of the slot 34 and the curved lower end 60 of the flange 58 of the door-locking handle 20 may cooperate to allow insertion of the flange portion 58 into the slot 34. That is, the flared portion 70 and the curved lower end 60 help slidably mount the second leg 54 of the door-locking handle 20 into the slot 34 of the door plate 18. The curved lower end 60 may slide along one of the ramped surfaces 72 to guide the second leg 54 into a position such that the flange portion 58 can be received into the slot 34 between the outer lateral surfaces 64 and the body portion 56 can extend out of the slot 34 between the inner lateral surfaces 68.

This is particularly beneficial during an emergency scenario (such as an active-shooter emergency) where a person attempting to engage the door-locking handle 20 into the door plate 18 and floor plate 16, to place the door security assembly 10 in the engaged position 46, may be extremely stressed and afraid for their life. In such a scenario, the person's hands may be shaking badly from extreme fear and/or adrenaline. The person may have difficulty quickly aligning the flange portion 58 between the outer lateral surfaces 64 and between the back and front surfaces 62, 66 and also aligning the body portion 56 between the inner lateral surfaces 68 so that the second leg 54 can be inserted into the slot 34 to engage the door-locking handle 20 with the door plate 18 and, subsequently, the first leg 52 with the floor plate 16. The ramped surfaces 72 of the flared portion 70 of the slot 34 are configured to guide the flange portion 58 into proper alignment with the slot 34 even if the person initially makes contacts between the door plate 18 and the door-locking handle 20 in a way that is out of alignment of the flange axis 51. The curved end 60 of the flange portion 58 also contributes to allowing the flange portion 58 to be guided into proper alignment with the slot 34.

As noted above, the disengagement assembly 13 includes the extension (or strap) 12 and the adapter 14. The disengagement assembly 13 is useful for quickly and efficiently moving the door security assembly 10 from the engaged position to the disengaged position. That is, the disengagement assembly 13 is configured to allow a person to rotate the door handle (e.g., the doorknob or lever) 24 and remove the door-locking handle 20 from the floor plate 16 and/or door plate 18 in a single motion. This allows a person to quickly and efficiently disengage the door-locking handle 20 and open the door 30 (and without having to bend down to grasp the door-locking handle 20 to disengage it from the floor plate 16 and/or door plate 18).

In an example as shown in FIGS. 1 and 2, the extension 12 can extend vertically upward from the door-locking handle 20 to the adapter 14 (which may be engaged with the door handle 24). The extension 12 includes a first end 82, a second end 84, and an intermediate portion 86 disposed between the first end 82 and the second end 84. The extension 12 can extend along an extension axis 80.

The first end 82 of the extension 12 can be looped around (e.g., attached, secured) to the strap slot 88 of the door-locking handle 20. The strap slot 88 can be a through-hole of the body portion 56 extending horizontally between the first leg 52 and the flange portion 58. In some configurations, the extension 12 could be connected to the door-locking handle 20 by looping the extension 12 around the second leg 54 or the extension 12 can be integral to the door-locking handle 20, for example. The extension 12 could be connected to the door-locking handle 20 in other suitable means, such as by a fastener (e.g., a bolt, rivet, pin, etc.) or adhesive, for example.

FIG. 1 depicts the door-locking handle 20 in the engaged position and the extension 12 is taught (or nearly taught) between the door-locking handle 20 and the door handle 24. FIG. 2 depicts the door-locking handle 20 in the disengaged position 48 and the strap 90 is pulled or lifted and, simultaneously, pulls the door-locking handle 20 from the aperture 26 of the floor plate 16. FIG. 2 depicts the strap 90 as being pulled when the door handle 24 and the adapter 14 are engaged (e.g., rotated), but the strap 90 can be pulled to lift the door-locking handle 20 from the slot 34 without engaging the door handle 24 and the adapter 14. To disengage the barricade assembly 11 with the door handle 24, the extension 12 should remain taught between the door-locking handle 20 and the adapter 14 to provide the transmission of movement between the door handle 24 and adapter 14 rotation to movement of the door-locking handle 20 by the extension 12 being lifted.

As shown in FIGS. 1 and 2, the extension 12 may be the strap with an adjuster 78 and a buckle 79. The strap adjuster 78 can be useful for increasing (e.g., lengthening, extending) or decreasing (e.g., shortening, contracting) the length of the intermediate portion 86 of the strap 90. The extension 12 can also be connected and disconnected from the body portion 56 of the door-locking handle 20 by the buckle 79. The buckle 79 can include a male portion 73 and a female portion 71. The buckle 79 can be useful for removing the extension 12 from the door locking assembly 10 for storage. It is contemplated the extension 12 can be without the strap adjuster 78 or the buckle 79, or both, and may instead have a length specific to reach the door-locking handle 20 and the adapter 14. It is also contemplated that the extension 12 can include an additional buckle 79 at or near the second end 84 for removal of the adapter 14.

As shown in FIGS. 1-3, the extension 12 may be attached to the adapter 14 at the second end 84 of the extension 12. The adapter 14 may include a pin 90, a pin hole 91, an extension hole 92, a handle slot 93, an outer circumference 94, an inner circumference 95, and engagement features 96. The adapter 14 can be useful for connecting the extension 12 to the door handle 24 of the door 30. The adapter 14 may also be useful for ergonomically disengaging the door-locking handle 20 from the floor plate 16 by lifting the door-locking handle 20 either wholly or partially from the slot 34 of the door plate 18 when the door handle 24 is rotated via the extension 12.

The adapter 14 is made of a resiliently bendable and/or resiliently compressible material (elastic material) to surround (e.g., connect, engage, etc.) and grip the door handle 24. The adapter 14 may be generally C-shaped and generally cylindrical, with the outer circumference 94 being the outer diameter of the cylindrical shape. The handle slot 93 and the outer circumference cooperate to define the C-shape. The handle slot 93 may be a wedge-shaped opening that allows the adapter 14 to open (e.g., bend) and be placed on, around, and/or over the door handle 24. The engagement features 96 may be formed on interior surfaces 97 of the handle slot 93, or on the inner circumference 95 of the adapter 14.

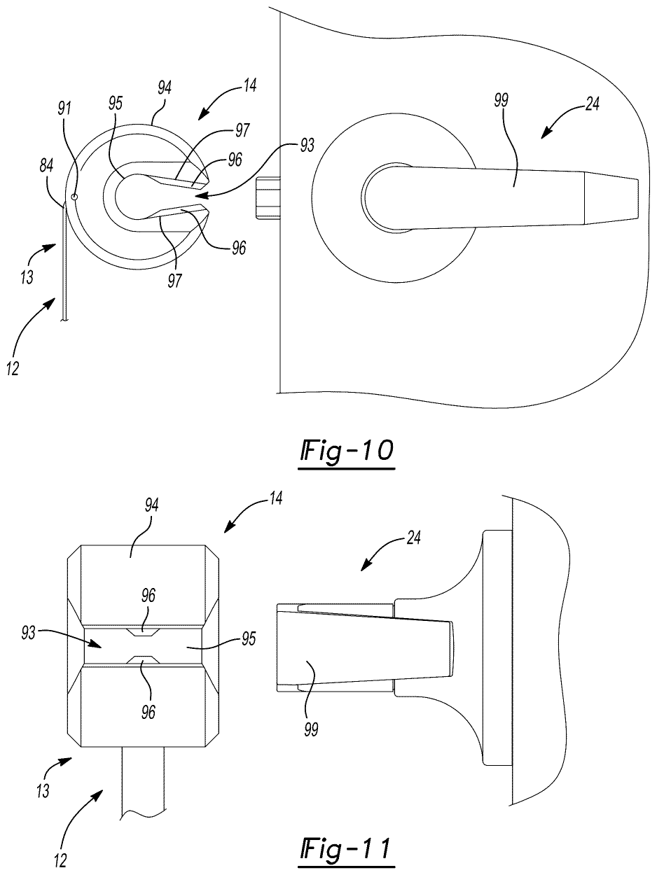

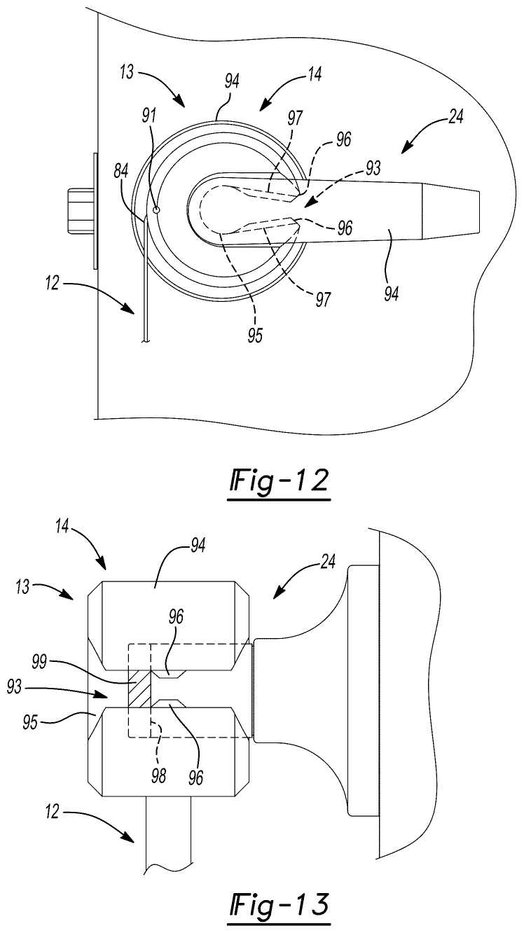

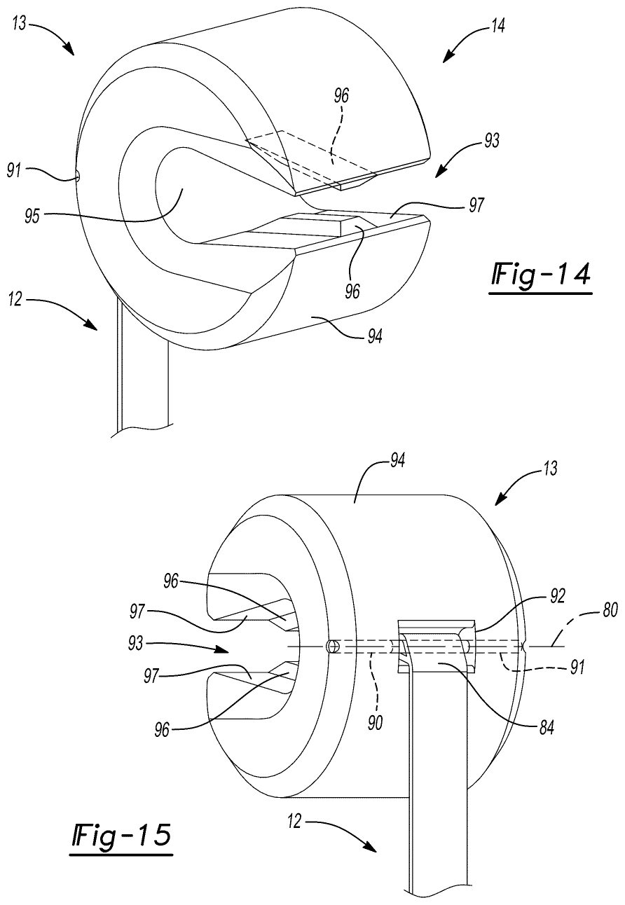

As shown in FIGS. 10-14, the engagement features 96 may be protrusions extending into the handle slot 93. As shown in FIG. 13, the engagement features 96 may abut or interfere with a back-face 98 of a lateral extension (or lever) 99 of the door handle 24 to inhibit the adapter 14 from being inadvertently removed from the door handle 24 along a door handle axis 100. The engagement features 96 could have any suitable shape or size.

As shown in FIGS. 3 and 15, the adapter 14 includes the pin 90 and the pin hole 91. The pin hole 91 is a through hole that extends wholly or partially through the length of the cylindrically shaped adapter 14. The pin hole 91 may extend either wholly or partially through the adapter 14 along a pin axis 80 that allows the second end 84 of the extension 12 to be attached to the adapter 14 at the extension hole 92 of the adapter 14. The pin 90 may provide the attachment of the extension 12 to the adapter 14 similar to the strap slot 88 of the door-locking handle 20, where the second end 84 of the extension 12 receives the pin 90 to be threaded (or inserted) through a hole in the second end 84. The second end 84 of the extension 12, the pin hole 91, the pin 90, and the extension hole 92 of the adapter 14 are aligned along the pin axis 80 to provide attachment of the extension 12 to the adapter 14 when the pin 90 is inserted into the pin hole 91. It is contemplated that the second end 84 of the extension can be attached to the adapter 14 through other means, such as hook-and-loop fasteners, adhesive, or other fastening methods as long as the rotation of the door handle 24 also lifts the door-locking handle 20 from the floor plate 16.

A second example door security assembly 110 is shown in FIG. 8. The structure and function of the second example door security assembly 110 with a barricade assembly 111 and a disengagement assembly 113 may be similar or identical to the first example door security assembly 10 with the barricade assembly 11 and the disengagement assembly 13 except that a patch 178 is attached (e.g., via stitching, adhesive, etc.) to a first end 182 of the extension 112. The extension 112 could be attached to the door-locking handle 120 by a hook-and-loop fastener as the patch 178. The patch 178 can have either the hooks or the loops of the hook-and-loop fastener. The patch 178 on the extension 112 can removably engage a patch 179 on the body portion 156 of the door-locking handle 120 that includes the other of the hooks or the loops of the hook-and-loop fastener. For example, the patch 179 can be adhesively bonded to the door-locking handle 120.

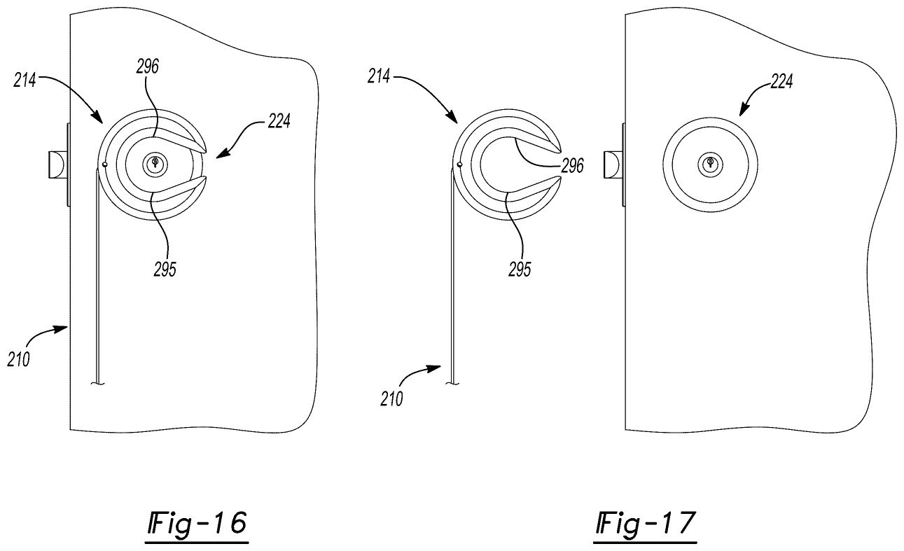

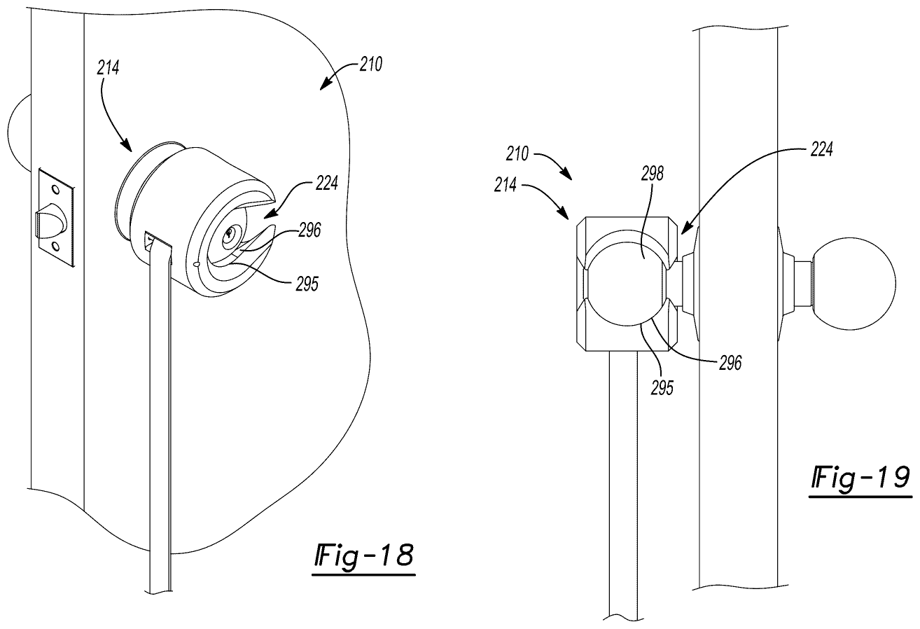

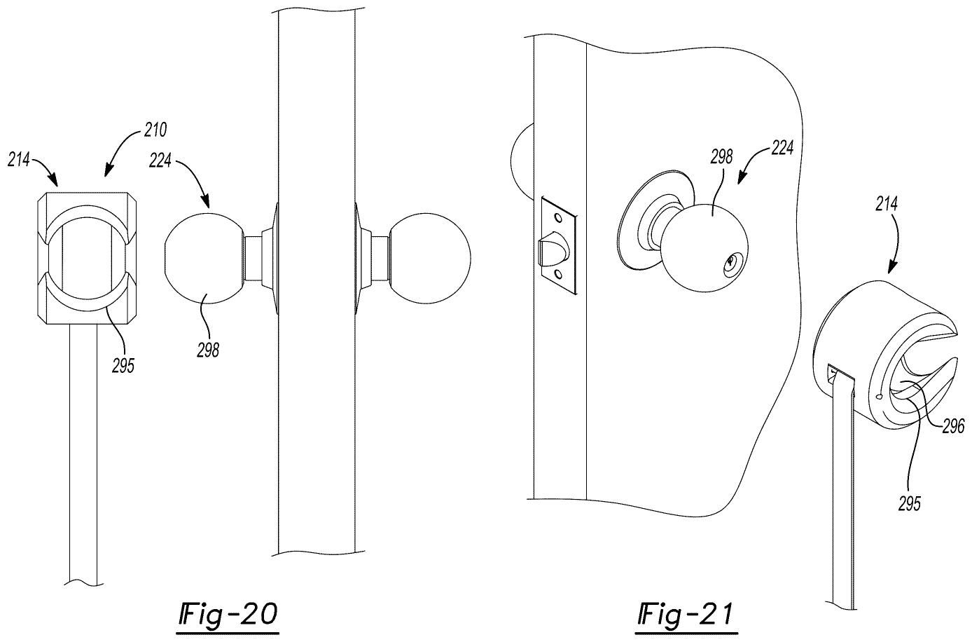

Another example of a door security assembly 210 is shown in FIGS. 16-21. The structure and function of the door security assembly 210 may be similar or identical to the first example door security assembly 10 except that the adapter 214 may attach to a door handle 224 without the lateral extension (or a round/spherical door handle). In this example the adapter 214 includes the engagement feature 296 on the inner circumference 295. The inner circumference 295 may be generally spherical to mirror the shape of the door handle 224 without the lateral extension. The spherical shape of the inner circumference 295 is the engagement feature 296 which allows the inner circumference 295 to directly interface with the back-face 298 of the door handle 224 as shown in FIGS. 19, 20, and 21. The adapter 214 surrounding the door handle 224, in this example, inhibits the adapter 214 from being pulled from the door handle 224 along the handle axis 300. It is contemplated the inner circumference 295 may include additional material (not shown) including an adhesive, other high-grip material (e.g., silicone, rubber, nitrile, etc.), and/or grip-enhancing surface textures (e.g., dimples, bumps, etc.) that may promote the grip of the spherical shape of the inner circumference 295 to the door handle 224.

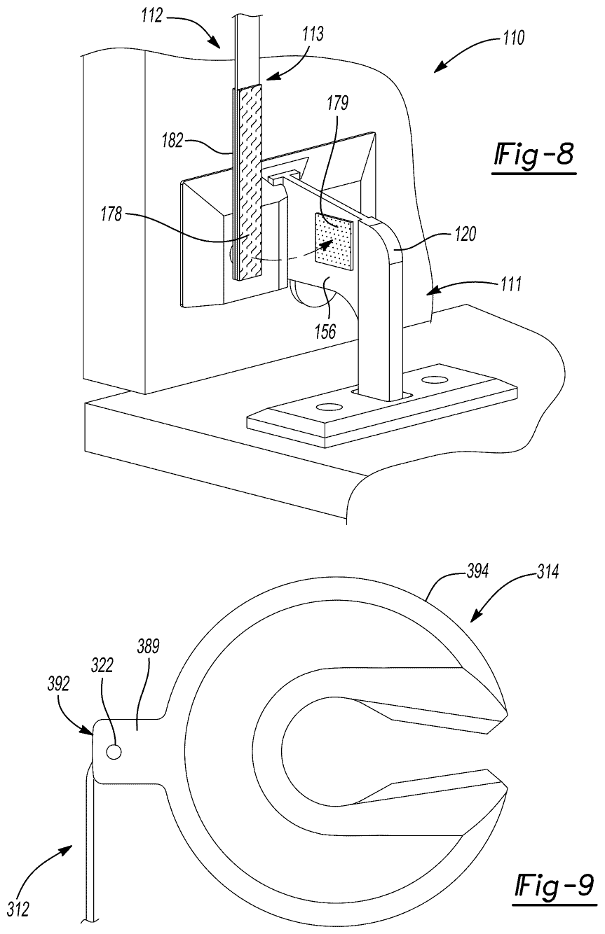

Another example of an adapter 314 is shown in FIG. 9. The structure and function of the adapter 314 may be similar or identical to the adapter 14 except that the adapter 314 includes a protrusion 389 extending radially from an outer circumference 394. In this example, an extension hole 392 for connecting an extension 312 and a pin hole 322 for inserting a pin 390 is in the protrusion 389, which connects the extension 312 at a distance from the outer circumference 394, thereby providing additional leverage for moving the extension 312 to remove the door-locking handle (not shown) in response to rotation of the adapter 314 and door handle 24.

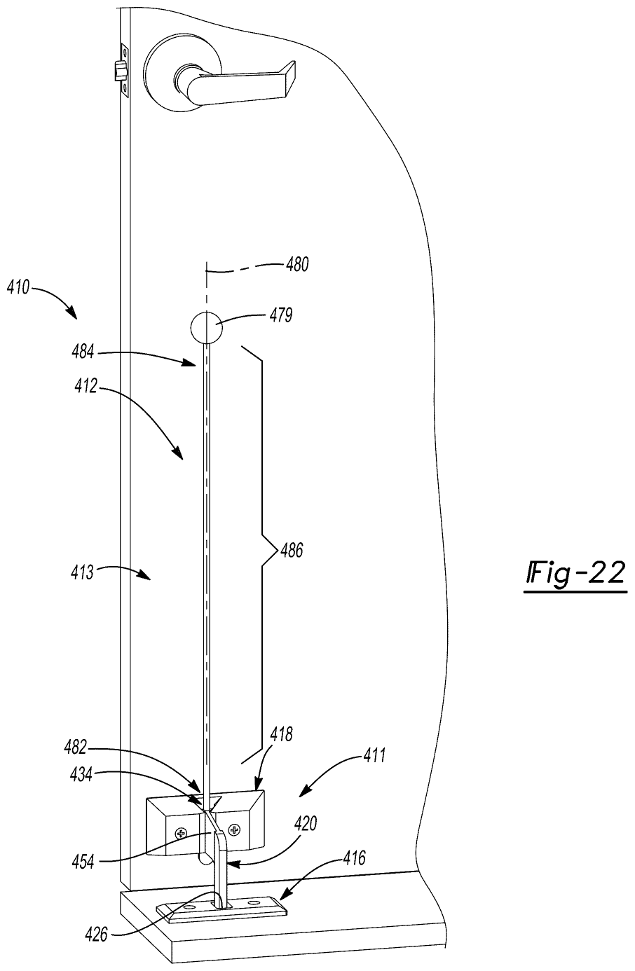

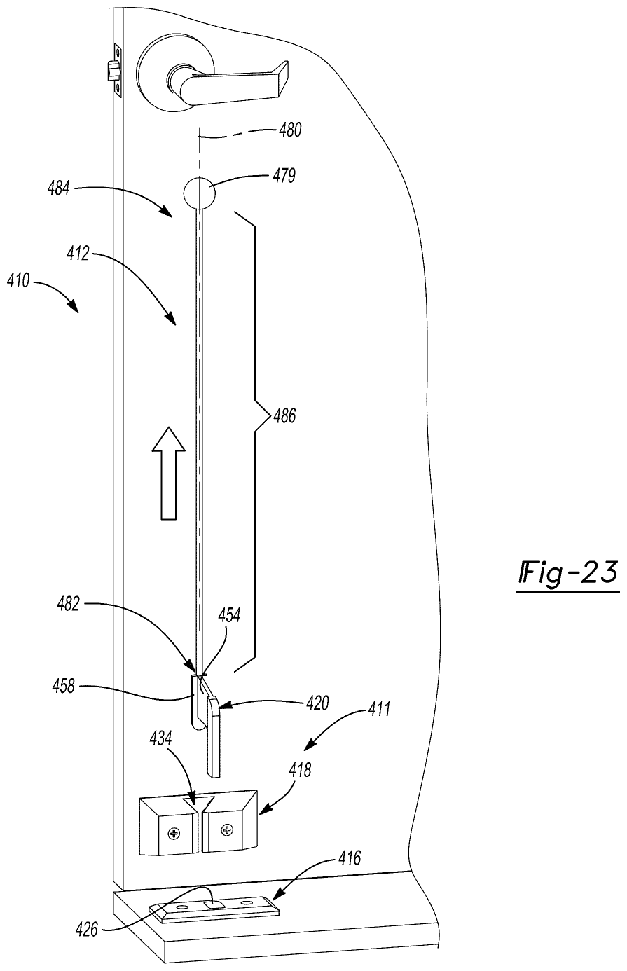

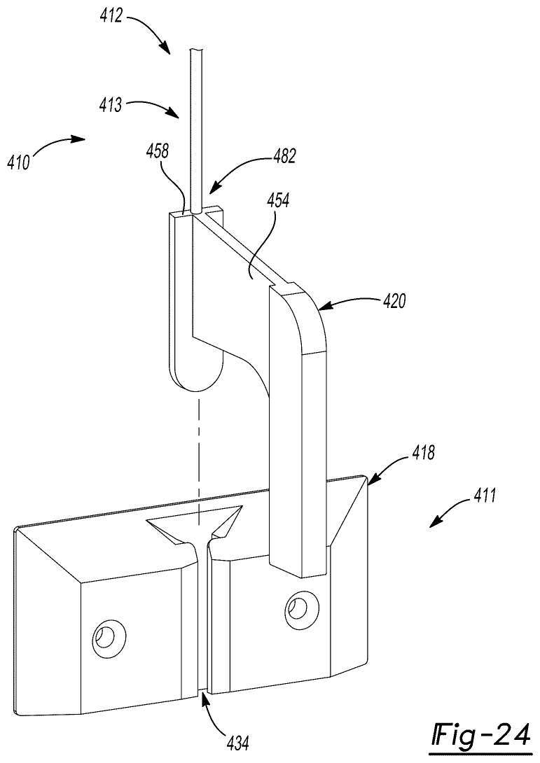

Another example of a door security assembly 410 is shown in FIGS. 22-24. The structure and function of the fourth example door security assembly 410 may be similar or identical to the first example door security assembly 10 except that the disengagement assembly 413 may include an extension 412 that is a rigid rod. Similar to the example shown in FIGS. 1 and 2, the extension 412 can include a first end 482, a second end 484, and an intermediate portion 486 between the first end 482 and the second end 484. The extension 412 may be a cylindrical, solid rod, but it is contemplated the extension 412 may be square, hexagonal, or consist of another type of cross-section. The extension 412 may also be hollow instead of solid. The extension 412 may be comprised of the same material as the door-locking handle 420, or another material that will maintain the shape of the extension 412. The extension 412, can be directly connected to (e.g., integral with) the door-locking handle 420. The extension 412 may also extend vertically from the second leg 454 along the extension axis 480.

As shown in FIGS. 22-24, the disengagement assembly 413 including the extension 412 may provide ergonomic disengagement of the door-locking handle 420 by allowing the extension 412 to be pulled (e.g., lifted) while also pulling (e.g., lifting) the flange portion 458 of the door-locking handle 420 from the slot 434 wholly or partially. The whole or partial removal of the flange portion 458 from the slot 434 allows the first leg 452 of the door-locking handle 420 to be removed from the first aperture 426 of the floor plate 416. The disengagement assembly 413 can be useful barricading doors 430 without door handles 424 and for rapid disengagement of the door-locking handle 420 from the first aperture 426 of the floor plate 416. The extension 412 can have a knob 479 at the second end 484. The knob 479 can be useful for ergonomically grabbing and lifting the door locking assembly 410 from the first and second plates 416,418.

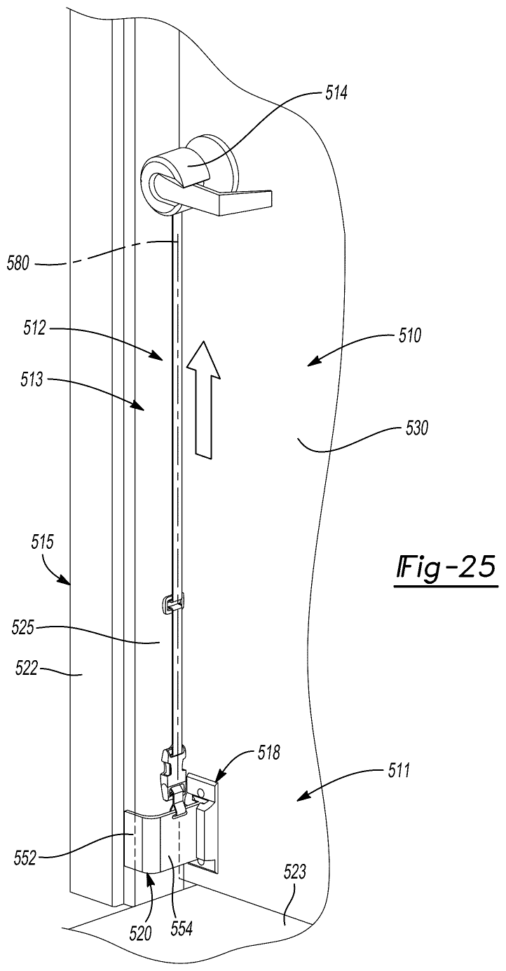

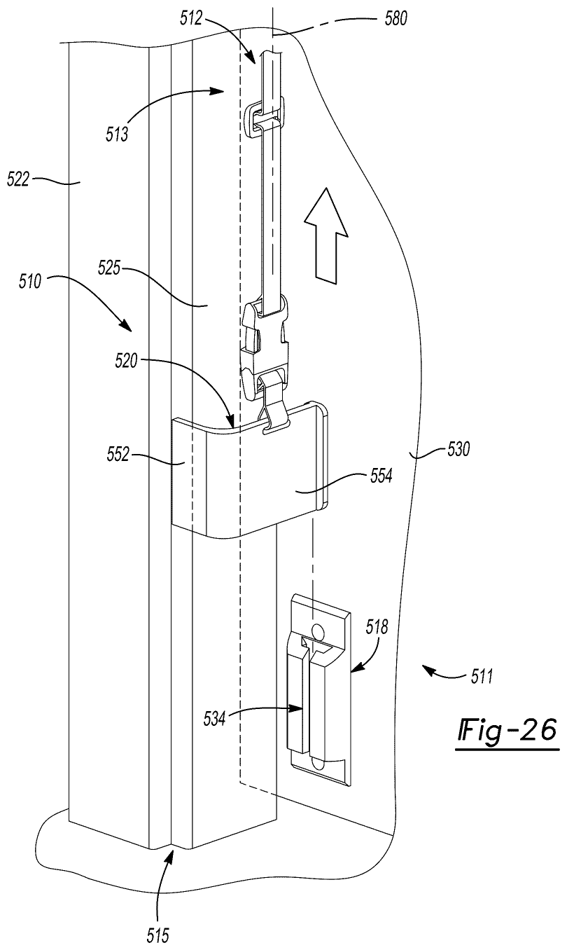

FIGS. 25 and 26 depict another example of a door security assembly 510 that may include a barricade assembly 511 and a disengagement assembly 513. The structure and function of the barricade assembly 511 and disengagement assembly 513 may be similar or identical to that of the barricade assembly 11 and disengagement assembly 13, except that the barricade assembly 511 is configured to barricade a door 530 without using the floor plate 16. The barricade assembly 511 can include a door plate 518 and a door-locking handle (e.g., a barricade) 520. The disengagement assembly 513 can include an extension (or strap) 512 and an adapter 514. The door security assembly 310 can be deployed to barricade the door 530 in a closed position, as shown in FIG. 25, to prevent unwanted opening of the door 530. The door-locking handle 520 can be engaged with the door plate 518 and a fixed door frame 515 to prevent a person on the opposite side of the door 530 from opening the door 530, thereby preventing the person from gaining access to a room or space in a building or home, for example. The door security assembly 510 may inhibit the door 530 from opening in the outward direction (away from the room containing the door security assembly 310). The extension 512 can extend along an extension axis 580.

As shown in FIGS. 25 and 26, the door frame 515 can include a door soffit. In the example provided, the door soffit is a side soffit 522 extending from a floor 523, vertically upward, though other configurations can be used. The door soffit 522 can include a door stop 525. The door-locking handle 520 may include a first leg 552 and a second leg 554 that cooperate to form a generally L-shaped member. The first leg 552 may extend generally perpendicularly from the second leg 554. When the door-locking handle 520 is engaged with a slot 534 the door plate 518, as shown in FIG. 25, the first leg 552 may interfere with the door stop 525 of the door frame 515 to prevent the door 530 from opening. The structure and function of the slot 534 may be similar or identical to the slot 34 of the first example door security assembly 10 as described above.

In some configurations, the first leg 552 may be in contact with the door stop 525 when the door-locking handle 520 is engaged with the door plate 518. In other configurations, the first leg 552 may be slightly spaced apart from the door stop 525 when the door 530 is fully closed and the door-locking handle 520 is engaged with the door plate 518, but the first leg 552 will still be in a position to interfere with the door stop 525 so that if the door 530 is moved slightly, the first leg 552 will contact the door stop 525 if the door 530 is moved to prevent the door 530 from being opened.

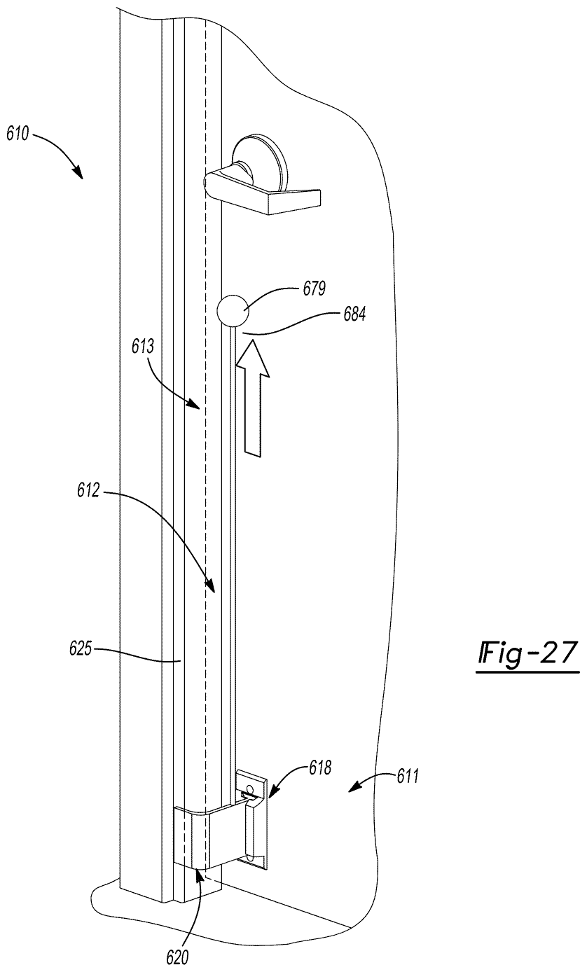

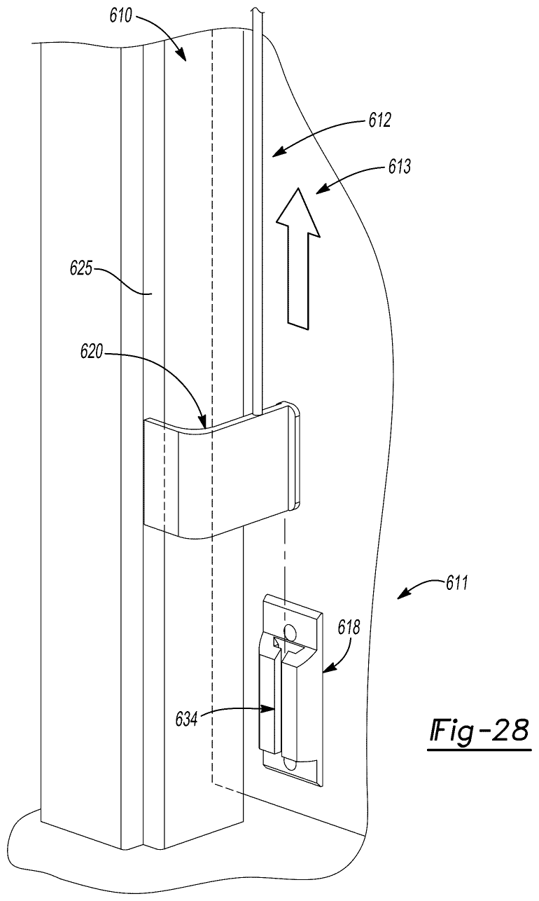

FIGS. 27 and 28 show another door security assembly 610 that includes a barricade assembly 611 and a disengagement assembly 613. The structure and function of the disengagement assembly 613 may be similar or identical to that of the disengagement assembly 413. The structure and function of the barricade assembly 611 may be similar or identical that of the barricade assembly 511, except that door-locking handle 620 engages the extension 612 as a rigid rod. The extension 612 is easily accessible to people of various levels of physical abilities and may provide fast and efficient disengagement of the door-locking handle 620 by allowing the extension 612 to be pulled (e.g., lifted) while also pulling (e.g., lifting) the door-locking handle 620 from the door plate 618. FIG. 27 depicts the door-locking handle 620 in the engaged position where the door-locking handle 620 is engaged to the door plate 618 and door stop 625. FIG. 28 depicts the door-locking handle 620 in the disengaged position where the door-locking handle 620 has disengaged from the slot 634 of the door plate 618 and the door stop 625. The extension 612 can have a knob 679 at the second end 684. The knob 679 can be useful for grabbing and lifting the door-locking handle 620 by lifting the extension 612 of the disengagement assembly 613.

The disengagement assemblies 13, 113, 213, 413, 513, 613 are easily operable by and accessible to people of various levels of physical abilities and provide fast and efficient disengagement of the door-locking handle to unbarricade the door.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A door security assembly for barricading a door, the door security assembly comprising:
a plate;
a door-locking handle configured to engage the plate and cooperate with the plate to barricade the door in a closed position; and
a disengagement assembly including an extension and an adapter, wherein the extension is connected to and extends vertically from the door-locking handle, wherein the adapter is connected to the extension and a door handle of the door;
wherein the disengagement assembly is configured to transmit motion of the door handle to the door-locking handle to disengage the door-locking handle from the plate.

2. The door security assembly of claim 1, wherein the extension is a strap including a first end and a second end, the first end of the strap is connected to the door-locking handle.

3. The door security assembly of claim 2, wherein the strap includes a strap adjuster configured to lengthen and shorten the strap.

4. The door security assembly of claim 2, wherein the strap includes a strap buckle configured to attach and remove the strap from the door-locking handle.

5. The door security assembly of claim 1, wherein the adapter is formed from a resiliently bendable material.

6. The door security assembly of claim 5, wherein the adapter is a cylindrical shape with an outer circumference and an inner circumference.

7. The door security assembly of claim 6, wherein the adapter includes a door handle slot, and the inner circumference of the adapter is configured to surround a door handle of the door via the door handle slot.

8. The door security assembly of claim 7, wherein the door handle slot of the adapter includes an engagement feature configured to interfere with at least one of a lever of the door handle and a spherical shape of the door handle to restrict disengagement of the adapter from the door handle.

9. The door security assembly of claim 8, wherein the adapter includes a protrusion extending from the outer circumference of the adapter configured to attach the extension and provide leverage to disengage the door-locking handle from the plate.

10. The door security assembly of claim 1, wherein the plate is a door plate including a slot removably engaging the door-locking handle and configured to be mounted to the door, wherein the door-locking handle includes a first leg and a second leg, the first leg of the door-locking handle is configured to engage at least one of a door soffit and a floor plate, and wherein the second leg of the door-locking handle is configured to slidably engage the slot of the door plate.

11. The door security assembly of claim 10, wherein the floor plate is configured to mount to a floor, the floor plate includes an aperture, the aperture is configured to receive the first leg of the door-locking handle.

12. The door security assembly of claim 1, wherein the plate is a floor plate including an aperture configured to be mounted to a floor, and wherein the floor plate includes an aperture that removable receives the door-locking handle.

13. A door security assembly for barricading a door, the door security assembly comprising:
a door-locking handle;
a plate configured to removably engage the door-locking handle; and
a disengagement assembly including:
an extension including a first end, a second end, and an intermediate portion extending between the first end and the second end, the first end of the extension is connected to and extends vertically from the door-locking handle; and
an adapter connected to the second end of the extension and including a door handle slot and an engagement feature, the door handle slot configured to at least partially surround a door handle of the door, the engagement feature configured to engage the door handle of the door;
wherein the adapter is configured to transmit rotational movement of the door handle to vertical movement of the extension, which moves the door-locking handle relative to the plate.

14. The door security assembly of claim 13, wherein the extension is a strap and includes a strap adjuster and a buckle, wherein the strap adjuster is configured to adjust a length of the intermediate portion of the extension, and the buckle is configured to removably attach the strap to the door-locking handle.

15. The door security assembly of claim 13, wherein the adapter is a resiliently bendable material having a cylindrical shape with an outer circumference and an inner circumference.

16. The door security assembly of claim 15, wherein the inner circumference of the adapter is configured to surround the door handle of the door via the door handle slot.

17. The door security assembly of claim 16, wherein the engagement feature of the adapter is configured to interfere with at least one of a lever of the door handle and a spherical shape of the door handle to restrict disengagement of the adapter from the door handle.

18. The door security assembly of claim 17, wherein the adapter includes a protrusion extending from the outer circumference of the adapter configured to attach the extension and provide leverage to disengage the door-locking handle from the plate.

19. The door security assembly of claim 13, wherein the plate is a door plate including a slot removably engaging the door-locking handle and configured to be mounted to the door, wherein the door-locking handle includes a first leg and a second leg, the first leg of the door-locking handle is configured to engage at least one of a door soffit and a floor plate, and wherein the second leg of the door-locking handle is configured to slidably engage the slot of the door plate.

20. A door security assembly for barricading a door, the door security assembly comprising:
a door-locking handle;
a plate configured to removably engage the door-locking handle; and
a rigid rod including a first end, a second end, and an intermediate portion extending between the first end and the second end, the first end of the rigid rod is connected to and extends vertically from the door-locking handle,
wherein movement of the rigid rod causes corresponding movement of the door-locking handle relative to the plate.

21. The door security assembly of claim 20, wherein the plate is a door plate including a slot removably engaging the door-locking handle and configured to be mounted to the door, wherein the door-locking handle includes a first leg and a second leg, the first leg of the door-locking handle is configured to engage at least one of a door soffit and a floor plate, the second leg of the door-locking handle is configured to slidably engage the slot of the door plate.

22. The door security assembly of claim 20, wherein the plate is a door plate configured to be mounted to the door, and wherein the door plate includes a slot that removably engages the door-locking handle.

23. The door security assembly of claim 20, wherein the plate is a floor plate configured to be mounted to a floor, and wherein the floor plate includes an aperture that removable receives the door-locking handle.
